(19) United States
(12) Patent Application Publication
(10) Pub. No.: US 2026/0237018 A1
(43) Pub. Date: Aug. 13, 2026

(54) MULTI-RESOLUTION WARPING

(71) Applicant: QUALCOMM Incorporated, San Diego, CA (US)

(72) Inventor: Eran Scharam, Misgav (IL)

(21) Appl. No.: 19/053,024

(22) Filed: Feb. 13, 2025

(51) Int. Cl. G06T 3/18

(52) U.S. Cl. CPC G06T 3/18

(57) ABSTRACT

This disclosure provides systems, methods, and devices for image signal processing that support a multi-resolution region-based rendering of image data. In a first aspect, a method of image processing includes receiving image data comprising one or more input image frames; receiving a regions map indicating one or more regions in the image data, wherein the regions map associates each region with one or one or more image parameters; assigning, based on the regions map, each coordinate of a subset of coordinates for an output image frame to one of the one or more regions; determining, for each coordinate, input pixels from a corresponding location in an input image frame having the image parameter associated with the respective region assigned to the coordinate; and determining the output image frame by warping the input pixels to align towards the subset of coordinates. Other aspects and features are also claimed and described.

### TECHNICAL FIELD

Aspects of the present disclosure relate generally to image processing, and more particularly, to resource optimization in image processing. Some features may enable and provide improved image processing, including improved processes for rendering image data that optimizes processing resources and reduces power consumption.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The amount of image data captured by an image sensor has increased through subsequent generations of image capture devices. The amount of information captured by an image sensor is related to a number of pixels in an image sensor of the image capture device, which may be measured as a number of megapixels indicating the number of millions of sensors in the image sensor. For example, a 12-megapixel image sensor has 12 million pixels. Higher megapixel values generally represent higher resolution images that are more desirable for viewing by the user.

The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data. For example, the image data may be processed through several processing blocks for enhancing the image before the image data is displayed to a user on a display or transmitted to a recipient in a message. Each of the processing blocks consumes additional power proportional to the amount of image data, or number of megapixels, in the image capture. The additional power consumption may shorten the operating time of an image capture device using battery power, such as a mobile phone.

The burden on resources resulting from the large amount of data can be particularly wasteful in situations where only a portion of a field of view (FOV) captured by the image data is relevant. For example, in mixed reality systems, a user may be interested in viewing an object within their FOV and their eyes may gaze towards a region of interest encompassing the object. The user may not remember, value, and/or process visual information from areas of the FOV further from the region of interest.

Typically, non-relevant areas of the FOV (e.g., areas away from an eye's gaze in a mixed reality device, passengers in a vehicle, background, etc.) can be blurred, cropped out, and/or otherwise minimized in image resolution. The unnecessary processing of large amounts of image data associated with non-relevant pixels of captured image data, even though these non-relevant pixels may be subsequently blurred, removed, and/or otherwise minimized in resolution at a later stage, results in unnecessary power consumption and processor bandwidth. Furthermore, the unnecessary processing by the image signal processors causes delays in the imaging pipeline, negatively affecting the user experience.

Various embodiments of the present disclosure address one or more of these aforementioned shortcomings.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure describes systems, methods, devices, and apparatuses for multi-resolution region-based rendering of image data. In various embodiments, such systems, methods, devices, and apparatuses utilize a warping engine that reads or otherwise receives image data that includes multiple image frames. The multiple image frames may correspond to a sensor frame based on one or more image sensors. In some embodiments, the multiple image frames may share an overlapping field of view (FOV) that are generated in multiple image parameters (e.g., resolutions, sizes, shapes, sources of captured image data, etc.) For example, a first image frame may be generated in a first image resolution and a second image frame may be generated in a second image resolution. The warping engine may determine, receive, and/or read a regions map. The regions map may indicate various regions of the FOV, such as a region of interest, and may further indicate the importance assigned to each region (e.g., based on an assignment of different levels of the image parameter such as an assignment of different levels of resolution). In some embodiments, the regions and the importance assigned to each region may be determined based on a detection and/or tracking of an object of interest (e.g., via facial recognition systems, object recognition systems, etc.). Also or alternatively, the importance may be determined by way of an eye tracking sensor (e.g., in a mixed reality setting) detecting where an eye of the user is gazing within a FOV captured by the image sensor device. The tracking of the gaze of the eye (e.g., the fovea) may be used to determine a regions map for foveated rendering of multi-resolution image data using the processes described herein. In some embodiments, the regions map may assign a different image parameter (e.g., image resolution) to each region. For example, the region of interest may be assigned the highest image parameter (e.g., highest image resolution) whereas a region of less importance may be assigned a lower image parameter (e.g., lower image resolution) or may be indicated as being invalid due to very low importance. Also or alternatively, the regions map may assign, to each region, an image frame of the multiple image frames having the multiple image resolutions. The assignment may be performed by way of an image frame identification (image frame ID).

The warping engine may determine a set of coordinates for the intended output image frame. Furthermore, for each coordinate, the warping engine may use the regions map to determine a region of the FOV in which the coordinate may be based. In some embodiments, in order to map the coordinate to a region, the warping engine may perform an inverse transformation of the set of coordinates of the intended output image frame to determine a set of virtual coordinates and then scale the virtual coordinates to the size of the regions map. Furthermore, based on the region associated with the coordinate, the warping engine may determine the image frame having the image parameter (e.g., image resolution) associated with the region. The warping region may then fetch pixels from the image frame to warp to the coordinate of the intended output image frame. For example, the warping engine may use the image ID associated with the region associated with the coordinate to identify the relevant image frame having the image parameter (e.g., image resolution) for that region. The warping engine may then fetch pixels from the identified image frame at a location that corresponds with the coordinate from the output image frame. After pixels for each coordinate of the set of coordinates of the output image frame are fetched, the fetched pixels may be warped on the basis of the set of coordinates of the output image frame and interpolated.

In some embodiments, a blending of pixels may be performed in areas of an output image frame corresponding to transitions between regions (e.g., a transition area between a region of interest associated with a high image resolution and another region associated with a low image resolution). In some embodiments, artifacts due to lens shading may be corrected by applying gain values to the interpolated pixels.

In some embodiments, the warping engine may perform these aforementioned steps prior to and/or concurrently with image signal processing tasks such as but not limited to lens correction, rolling shutter correction, time warp, OLED raster correction. In some embodiments, the warping engine may be a part of, may be associated with, or may be executed by a display processing unit.

The aforementioned techniques conserves bandwidth and other processing resources, reduces power consumption, and provide a more efficient delivery of image output by avoiding the unnecessary processing of non-relevant pixels of an image data associated with regions that may not be of interest to a user. For example, a device or apparatus (e.g., image capture device) may be able to avoid or otherwise defer the image processing of the multiple image frames having the multiple resolutions until an output image frame is generated. As the output image frame may use pixels from the high resolution image frame for only a portion of the output image frame, and as other portions of the output image frame may use pixels from lower resolution image frame or may be rendered as invalid, the device or apparatus may be able to avoid the burden of having to image process each of the multiple image frames having the different multiple image resolutions in their entireties. Additionally, the use of the regions map may enable the combination of image processing tasks at the point of generating the output image frame, rather than having to perform the image processing tasks for each of the multiple images having the multiple resolutions. Furthermore, use of the warping engine configured to perform the aforementioned process may be built into, situated within, or otherwise programmed into the display processing unit (DPU). As processing by the DPU typically occurs at a later stage of an image processing and delivery pipeline, the deferment of image processing of image frames after multi-resolution region based rendering of image data has been performed by the warping engine of the DPU alleviates the processing burden otherwise faced by components earlier in the pipeline, such as the graphic processing unit and image signal processors.

In one aspect of the disclosure, a method for image processing includes: receiving, by a processor, image data comprising one or more input image frames; receiving, by the processor, a regions map indicating one or more regions in the image data, wherein the regions map associates each region with one of one or more image parameters; assigning, by the processor and based on the regions map, each coordinate of a subset of coordinates for an output image frame to one of the one or more regions; determining, by the processor, for each coordinate of the subset of coordinates for the output image frame, one or more input pixels from a corresponding location in one of the one or more input image frames having an image parameter associated with a region assigned to the coordinate; and determining, by the processor, the output image frame by warping the one or more input pixels to align towards the subset of coordinates for the output image frame.

In some embodiments, determining the output image frame by warping the set of one or more input pixels includes: interpolating, by the processor, the one or more input pixels. Furthermore, in some embodiments, assigning each coordinate of the subset of coordinates for the output image frame includes: determining a set of coordinates for the output image frame that includes the subset of coordinates; and determining, via an inverse transformation of the set of coordinates, a virtual set of coordinates that is scaled to the regions map. Even further, in some embodiments, the one or more image parameters includes at least two different image resolutions. The at least two input image frames includes at least a first input image frame having a first image resolution and a second input image frame having a second image resolution. The one or more regions includes at least a first region associated with the first image resolution and a second region associated with the second image resolution. Determining the output image frame by warping the one or more input pixels includes: blending, by the processor, at least one of the one or more input pixels from the first input image frame with at least one of the one or more input pixel from the second input image frame.

In an additional aspect of the disclosure, an apparatus includes at least one processor and a memory coupled to the at least one processor. The at least one processor is configured to: receive image data comprising one or more input image frames; receive a regions map indicating one or more regions in the image data, wherein the regions map associates each region with one of one or more image parameters; assign, based on the regions map, each coordinate of a subset of coordinates for an output image frame to one of the one or more regions; determine, for each coordinate of the subset of coordinates for the output image frame, one or more input pixels from a corresponding location in one of the one or more input image frames having an image parameter associated with a region assigned to the coordinate; and determine the output image frame by warping the one or more input pixels to align towards the subset of coordinates for the output image frame.

In some embodiments, the at least one processor is further configured to: determine, via an eye tracking sensor, the region of interest in an overlapping field of view (FOV) shared by the one or more input image frames; and generate the regions map based on the region of interest.

In an additional aspect of the disclosure, an image capture device is disclosed for multi-resolution region-based rendering of image data. The image capture device includes: an image sensor configured to generate image data including at least two input image frames; a memory storing processor-readable code; and at least one processor coupled to the memory and to the image sensor. The at least one processor is configured to: receive the image data including the at least two input image frames; receive a regions map indicating at least two regions in the received image data, wherein the regions map associates each region with one of at least two different image parameters; determine, based on the received image data, a set of coordinates for an output image frame, wherein the set of coordinates define a morphology for the output image frame; assign, based on the regions map, each coordinate of a set of coordinates for an output image frame to one of the at least two regions, wherein the set of coordinates define a morphology for the output image frame; determine, for each coordinate for the output image frame, one or more input pixels from a corresponding location in one of the at least two input image frames having an image parameter associated with a region assigned to the coordinate; and determine the output image frame by warping the one or more input pixels to align towards the morphology defined by the set of coordinates for the output image frame and interpolating the one or more input pixels after warping the one or more input pixels.

In an additional aspect of the disclosure, a non-transitory computer-readable medium stores instructions that, when executed by a processor, cause the processor to perform operations. The operations include: receiving, by a processor, image data comprising one or more input image frames; receiving, by the processor, a regions map indicating one or more regions in the image data, wherein the regions map associates each region with one of one or more image parameters; assigning, by the processor and based on the regions map, each coordinate of a subset of coordinates for an output image frame to one of the one or more regions; determining, by the processor, for each coordinate of the subset of coordinates for the output image frame, one or more input pixels from a corresponding location in one of the one or more input image frames having an image parameter associated with a region assigned to the coordinate; and determining, by the processor, the output image frame by warping the one or more input pixels to align towards the subset of coordinates for the output image frame.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same fields of view. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3 is a schematic of an example process for multi-resolution region-based rendering of image data using a warping engine according to non-limiting embodiments of the present disclosure.

FIG. 4 is a block diagram showing an example data flow path across components used for multi-resolution region-based rendering of image data, according to non-limiting embodiments of the present disclosure.

FIG. 5 shows a flow chart of an example method for processing image data for multi-resolution region-based rendering, according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for multi-resolution region-based rendering.

As previously discussed, the increasing amount of image data captured by image capture devices coupled with the demand for high image resolution results in increased processing, excessive power consumption, and reduced operating time for battery power devices. Such resource burden is particularly wasteful when only a portion of an image data may be relevant. For example, in mixed reality systems, a user may only be interested in viewing an object within their field of view (FOV). For automotive cameras inside ride share operations, a crucial element of the image being captured may be the driver, as other aspects of the image (e.g., passengers) may be unnecessary or may be privacy compromising. In yet another example, in online conference platforms, it may be desirable for cameras to show a speaker or participant, while minimizing the blurring the background. In these aforementioned and other examples, the region of interest is a small portion of a captured FOV. Therefore, full image processing of the entirety of the FOV can be wasteful. Furthermore, conventional techniques for blocking, minimizing the resolution of, or blurring non-relevant aspects of a captured image data fail to significantly reduce the aforementioned resource burden faced by image capture devices. In particular, rendering of image data to optimize focus on regions of interest while minimizing focus on less relevant regions is typically performed at a later stage in an image capture and delivery pipeline, after the image data captured by the image sensors has already been image processed to form output image frames. For example, such rendering to remove or minimize the importance of non-relevant aspects of the field of view typically occur at a display unit prior to an output image data being displayed. The unnecessary processing of large amounts of image data associated with non-relevant pixels of captured image data before such image data can be subsequently blurred, removed, and/or otherwise minimized in resolution at a later stage results in unnecessary power consumption and processor bandwidth. Furthermore, the unnecessary processing by the image signal processors causes delays in the imaging pipeline, negatively affecting the user experience.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

Various embodiments of the present disclosure address one or more of the aforementioned shortcomings. For example, various embodiments describe systems, methods, devices, and apparatuses for multi resolution region-based rendering of image data that utilize a warping engine. The warping engine receives image data that includes multiple image frames of a FOV that are generated in multiple image resolutions, and also receives a regions map indicating various regions of the field of view, such as a region of interest. Such received image frames may be referred to herein as “input image frames.” The regions map may further assign a different image resolution to each region based on the level of importance of the region. For example, a region of interest may be assigned the highest image resolution or an input image frame having the highest image resolution.

The warping engine may determine a set of coordinates for an intended output image frame. The warping engine may use the regions map to determine a corresponding region (e.g., in which the output coordinate are mapped to the input image). Based on the region associated with the input coordinate, the warping engine may determine the image frame having the image resolution associated with the region. The warping engine may then fetch one or more pixels from the input image frame to warp to the coordinate of the intended output image frame. For example, the warping engine may fetch one or more pixels from the identified image frame at a location that corresponds with the coordinate from the output image frame. That location may be determined by scaling the coordinate proportionately based on the size of the identified input image. After a set of pixels are fetched for each coordinate of the set of coordinates of the output image frame, the fetched set of pixels may be interpolated to create output pixels for the output image frame. In some embodiments, warping engine may blend pixels in areas of an output image frame corresponding to transitional areas between regions in the regions map (e.g., a transition area between a region of interest associated with a high image resolution and another region associated with a low image resolution). In some embodiments, the warping engine may perform these aforementioned steps prior to and/or concurrently with image signal processing tasks such as but not limited to lens correction, rolling shutter correction, time warp, OLED raster correction. In some embodiments, the warping engine may be a part of, may be associated with, or may be executed by a display processing unit (DPU).

Particular implementations of the subject matter described in this disclosure may be implemented to realize one or more of the following potential advantages or benefits. In some aspects, the present disclosure provides techniques for conserving image processor bandwidth and other processing resources, reducing power consumption, and providing a more efficient delivery of image output by avoiding the unnecessary processing of non-relevant pixels of an image data associated with regions that may not be of interest to a user. For example, a device or apparatus (e.g., image capture device) may be able to avoid or otherwise defer the image processing of the multiple image frames having the multiple resolutions until an output image frame is generated. As the output image frame may use pixels from the high resolution image frame for only a portion of the output image frame, and as other portions of the output image frame may use pixels from lower resolution image frame or may be rendered as invalid, the device or apparatus may be able to avoid the burden of having to image process each of the multiple image frames having the different multiple image resolutions in their entireties. Additionally, the use of the regions map may enable the combination of image processing tasks at the point of generating the output image frame, rather than having to perform the image processing tasks for each of the multiple images having the multiple resolutions. Furthermore, use of the warping engine to perform the aforementioned process in the display processing unit (DPU) may alleviate the processing burden on the graphic processing unit and image signal processors..

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

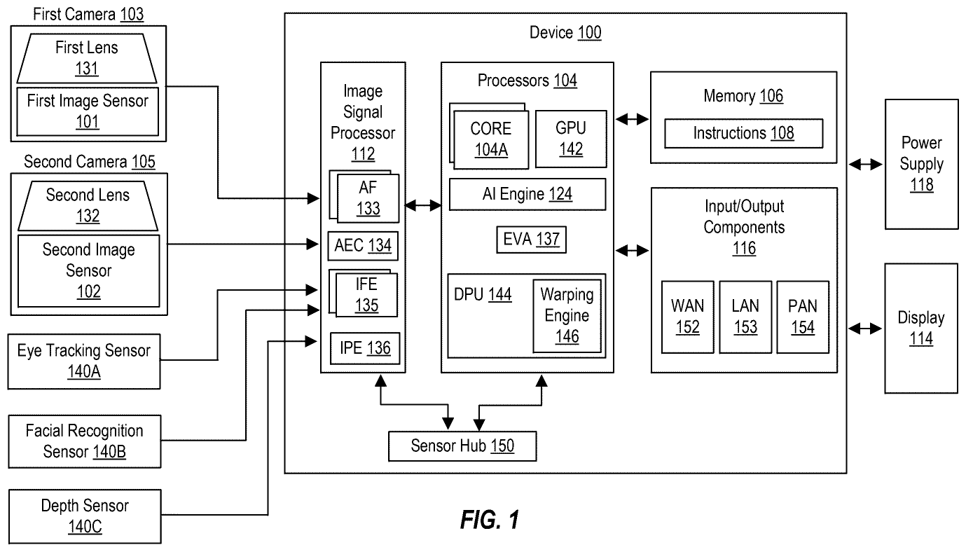

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, a depth sensor 140C, and one or more sensors to determine an object or region of interest, such as but not limited to an eye tracking sensor 140A or a facial recognition sensor 140B. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of objects within a FOV of an image sensor, movement of an eye (e.g., for mixed reality platforms), movement of the device 100 or an object within a field of view of an image sensor 101 or 102, data regarding an environment around the device 100, and/or other non-camera sensor data. One example of a non-camera sensor is an eye tracking sensor 140A. The eye tracking sensor 140A may be configured to track a fovea of the eye as it gazes towards various locations within a FOV of an image sensor. Another example of a non-camera sensor is a facial recognition sensor 140B. The facial recognition sensor 140B may be a second image sensor configured to detect and track a face within a field of view of an image sensor based on a facial recognition system (e.g., AI and/or machine learning model). Another example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated by the sensor hub 150. One or more of the object recognition and tracking (e.g., of an eye, a face, etc.), acceleration, velocity, and/or distance may be included in data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as plurality of image frames, whether received from the first camera 103 and/or second camera 105 or converted from analog data received from the first camera 103 and/or second camera 105. The plurality of image frames may comprise image frames in different image resolutions. For example, for an overlapping FOV, the image sensors may capture and output an image frame in a low image resolution, an image frame in a high image resolution, etc. In some embodiments, each image frame and/or the image resolution of the respective image frame may be identifiable via an image identification (image ID) for retrieval or access by other components of the device 100 (e.g., by the warping engine 146).

The first camera 103 may include the first image sensor 101 and a first lens 131. The second camera may include the second image sensor 102 and a second lens 132. Each of the first lens 131 and the second lens 132 may be controlled by an associated autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have or may share an overlapping FOV. Alternatively, the first lens 131 and second lens 132 may have different FOVs to capture different representations of a scene. For example, the first lens 131 may be an ultra-wide (UW) lens and the second lens 132 may be a wide (W) lens. The multiple image sensors may include a combination of UW, W, tele (T), and ultra-tele (UT) sensors.

The one or more cameras of device 100 (e.g., first camera 103, second camera 105, etc.) may be configured through hardware configuration and/or software settings to obtain an FOV or an overlapping FOV in different image resolutions. For example, first camera 103 may be configured to capture an image of a FOV in a first image resolution while second camera 105 may be configured to capture the FOV in a second image resolution. Also or alternatively. each of the first camera 103 and second camera 105 may be configured through hardware configuration and/or software settings to obtain different, but overlapping, FOVs. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-wide FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)), image front ends (e.g., IFE 135) configured to perform one or more operations described in the present disclosure (e.g., image capture, image frame generation in multiple image resolutions, etc.).

As will be described herein, various embodiments of the present disclosure provide for improved efficiency and alleviation of processing burden faced by image signal processors, by deferring the post processing of image data after a warping engine 146 has determined which image data to use for output image frames based on knowledge of relevant regions of interest. This deferring of image post processing may help avoid redundant or unnecessary processing of, or reduce the processing load for, pixels in less relevant parts of a field of view. For example, as will be described, engines for image post-processing and other operations typically performed by image signal processors 112 may be performed at a later stage in the imaging pipeline. For example, as shown in FIG. 1, such post-processing operations may be performed by one or more processors 104, such as one or more image post processing engines (IPE 136), auto exposure compensation (AEC) engines 134, and/or engines for video analytics (e.g., EVA 137). Alternatively, in some embodiments, the ISP 112 may further include the one or more image post-processing engines, auto exposure compensation (AEC) engines, and/or one or more engines for video analytics.

An image pipeline may be formed by a sequence of one or more of the IFE 135, GPU 142, warping engine 146, IPE 136, and/or EVA 137. In some embodiments, the image pipeline may be reconfigurable in the ISP 112 and/or by one or more processors 104 by changing connections between the IFE 135, GPU 142, warping engine 146, IPE 136, and/or EVA 137. The AF 133, AEC 134, IFE 135, GPU 142, warping engine 146, IPE 136, and EVA 137 may each include application-specific circuitry, be embodied as software or firmware executed by the ISP 112, processors 104, and/or a combination of hardware and software or firmware executing on the ISP 112 or processors 104.

The memory 106 may include a non-transient or non-transitory computer readable medium storing computer-executable instructions as instructions 108 to perform all or a portion of one or more operations described in this disclosure. The instructions 108 may include operations for the use of a regions map to determine relevant and non-relevant regions of a field of view, retrieving pixels from image frames of the field of view associated with different image resolutions, and determining an output image frame based on the warping and interpolation of the retrieved pixels. The instructions 108 may further include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record and display images using the first camera 103 and/or second camera 105, the ISP 112, the GPU 142, and one or more components of the display processing unit 144 (e.g., the warping engine) as will be described herein.

In addition to instructions 108, the memory 106 may also store image frames and a regions map. The image frames may be image frames based on image data captured by image sensors and stored by the ISP 112. These image frames, referred to herein as input image frames may be accessed by the processor 104 for further operations (e.g., performed by the warping engine 146) before being output as output image frames. The regions map may indicate, for an overlapping FOV shared by image frames having different image resolutions, various regions of the FOV. These regions of the regions map may be associated with or otherwise assigned to different image resolutions. Such assignments may be used by one or more processors 104 (e.g., the warping engine 146) to fetch pixels from input image frames having the assigned image resolution for each region, in order to generate or determine the output image frame.

In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or one of the processors 104 executes instructions to perform various operations described herein, including image capture, generation of multiple image frames having multiple respective image resolutions for an overlapping FOV, generation and use of a regions map, determining and using a set of coordinates designated for an output image frame, fetching pixels from the multiple image frames based on regions of the regions map, and determining the output image frame. As shown in FIG. 1, the one or more processors 104 include but are not limited to a graphical processing unit (GPU) 142, an AI engine 124, and a display processing unit (DPU) 144.

For example, execution of the instructions can instruct the ISP 112 to begin or end capturing multiple image frames of an FOV or of an overlapping FOV in multiple respective image resolutions, as described in embodiments herein. In some embodiments, a sequence of image frames or a sequence of sets of image frames may be captured, with each image frame having a different image resolution..

Furthermore, execution of the instructions can instruct the GPU 142 to perform one or more corrections to the input image frames, such as but not limited to lens distortion correction, rolling shutter compensation, time warp, OLED raster correction, and/or anamorphic compression 410. However, in some embodiments, the aforementioned corrections may be performed at a later stage in the imaging pipeline (e.g., by the DPU 144).

Execution of the instructions can instruct the DPU 144 (e.g., via the warping engine) to determine a set of coordinates for an intended output image frame (e.g., to be displayed); use the regions map to identify an image resolution and an associated input image frame for each coordinate, fetch pixels from the input image frame for each coordinate, warp and interpolate the fetched pixels based on the set of coordinates, and blend pixels as appropriate to determine or generate the output image frame. In some embodiments, the DPU 144 may be configured to perform one or more corrections for the output image frame, such as but not limited to chromatic aberration correction, image upscaling, or an anamorphic decompression. In some embodiments, the aforementioned corrections may be performed via the IPE 136 and/or the EVA 137.

In some embodiments, the processor 104 may include one or more general-purpose processor cores 104A-N capable of executing instructions to control operation of the ISP 112, the GPU 142, the AI engine 124, or the display processing unit 144. For example, the cores 104A may execute a camera application (or other suitable application for generating images or video) stored in the memory 106 that activate or deactivate: the ISP 112 for capturing image frames and/or control the ISP 112 in the application of generating image frames of an FOV or an overlapping FOV in different image resolutions; and the DPU 144 for the use of a regions map to determine and fetch pixels from input image frames of different image resolutions (e.g., based on regions of the regions map), and for warping and interpolating those pixels for an output image frame. In some embodiments, the ISP 112 may also determine or generate a regions map based on various sensors or object recognition systems indicating a region of interest (e.g., such as but not limited to the eye tracking sensor 140A or the facial recognition sensor 140B). The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, eye detection and tracking, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training..

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. Furthermore, while the GPU 142 and DPU 144 are shown as being part of the one or more processors 104, one or both of the GPU 142 and DPU 144 may be separate from the processor 104 and may have their own set of cores. Furthermore, while the warping engine 146 is shown as being part of the DPU 144, it is contemplated that, in some embodiments, the warping engine 146 may be separate from the DPU 144. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

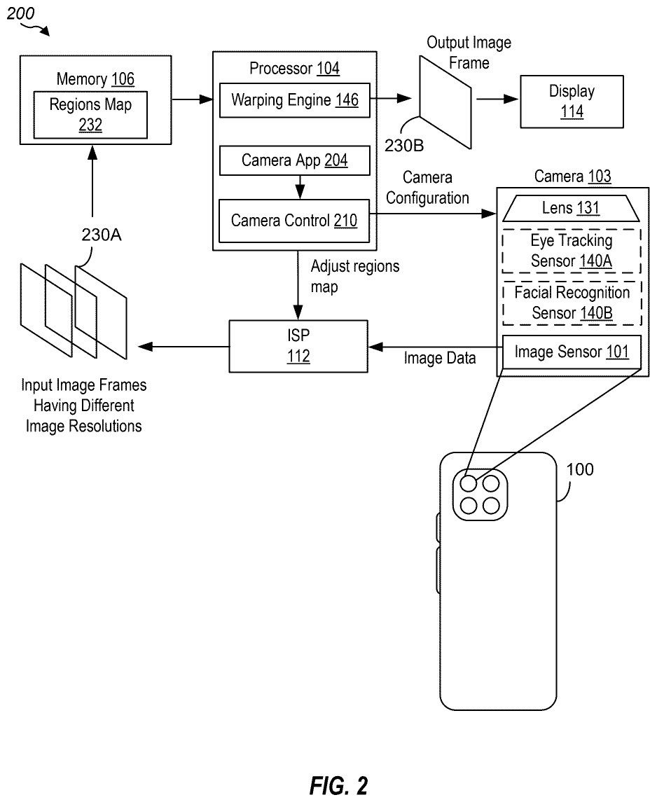

The exemplary image capture device of FIG. 1 may be operated to obtain region-based rendering of multi-resolution image data via the warping engine 146 to provide more efficient use of processing resources and reduce power consumption. One example method of operating one or more cameras, such as first camera 103 and/or second camera 105, is shown in FIG. 2 and described below.

FIG. 2 is a block diagram illustrating an example data flow path for image data processing in an image capture device according to one or more embodiments of the disclosures. One or more processors 104 of system 200 may communicate with ISP 112 through a bi-directional bus and/or separate control and data lines. The processors 104 may control the first camera 103 through camera control 210. The camera control 210 may be a camera driver executed by the processors 104 for configuring the first camera 103, such as to active or deactivate image capture, configure exposure settings, and/or configure aperture size. Camera control 210 may be managed by a camera application 204 executing on the processors 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processors 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine or generate multiple image frames 230 having different image resolutions that may be stored in memory 106 and/or otherwise provided to the processor 104. The memory 106 may further store a regions map 232 indicating regions of the FOV presented by or shared by the multiple image frames 230. The regions, which may include a region of interest, may be assigned different image resolutions (e.g., based on the importance of the region or the proximity to or identification with the region of interest). The regions map 232 may be generated by the ISP 112 and/or the camera 103. In some embodiments, the regions map 232 may be based on the detection and tracking of an eye of a user viewing different regions of a field of view of the image sensor 101 (e.g., via an eye tracking sensor 140A). Also or alternatively, the regions map 232 may be based on object recognition or tracking within the image data via sensors. For example, the regions map based on the detection and tracking of a face via a facial recognition sensor 140B. The processors 104 may process the image frames to determine an output image frame 230B using the regions map. For example, the processors 104 (e.g., the warping engine 146) may determine a set of coordinate for the output image frame 230B, identify regions in the regions map corresponding to each coordinate, determine and fetch pixels from an input image frame corresponding to the region for the coordinate, and warp and interpolate the fetched pixels for the set of coordinate to determine the output image frame. Furthermore, the one or more processors 104 may apply effects to the output image frame 230B. Effects may include Bokeh, lighting, color casting, and/or high dynamic range (HDR) merging. In some embodiments, the effects may be applied in the ISP 112.

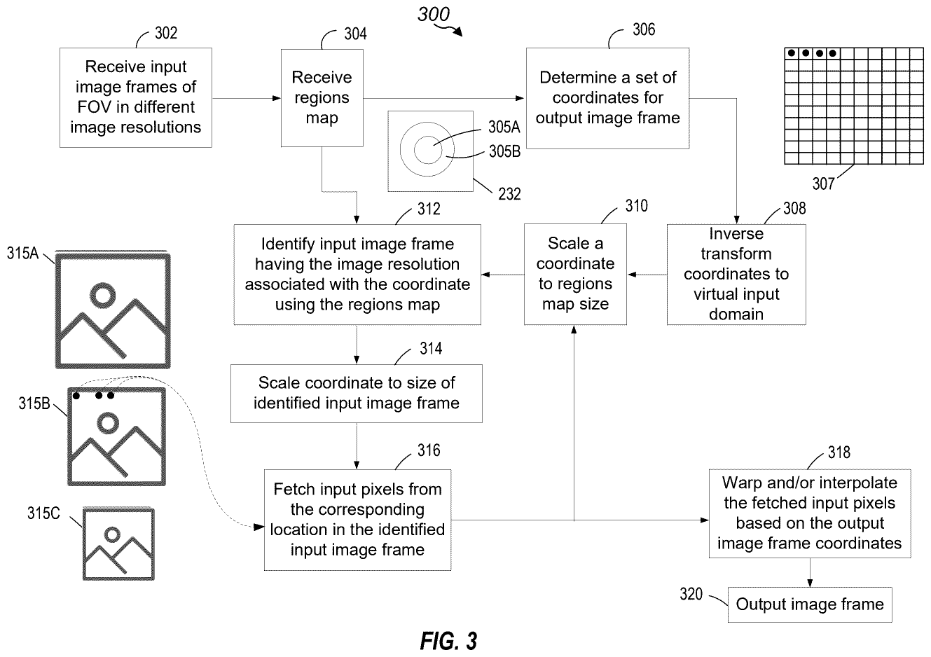

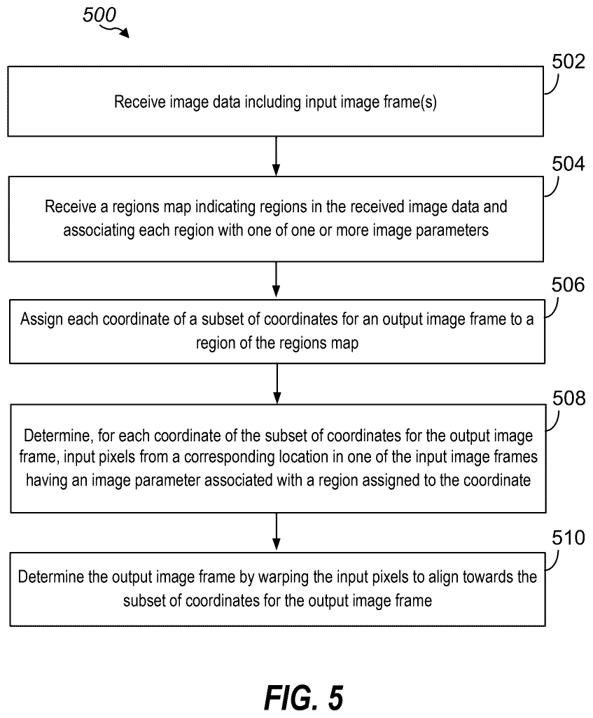

The output image frames 230B may include representations of the scene improved by aspects of this disclosure, such that regions of higher interest may exhibit higher image resolution while regions of lower interest may be invalidated or exhibit lower image resolution through a process that conserves processor bandwidth, reduces power consumption, and improves efficiency of image delivery. The processor 104 may display these output image frames 230 to a user, and the improvements provided by the described processing implemented in the ISP 112 and various components of the processor 104 (e.g., warping engine 146) to improve the image quality, conserve processing resources, and enhance the user experience by making image delivery more efficient and optimizing resolution for more relevant aspects of an image or video while reducing resolution for less relevant aspects of the image or video. For example, image post processing and correction of one or more of the multiple input image frames 230A may be avoided and/or deferred until the warping engine 146 has determined which pixels from which input image frame are to be used in the output image frame 230B. It is contemplated that various aforementioned processes may be repeated, for example, to determine and/or generate a sequence of output image frames 230B (e.g., for an image data stream or video) based on a sequence of sets of multiple image frames 230A having the different image resolutions. The system 200 of FIG. 2 may be configured to perform the operations described with reference to FIGS. 3 and 5 to determine the output image frame 230B.

FIG. 3 is a schematic of an example process for multi-resolution region-based rendering of image data using a warping engine according to non-limiting embodiments of the present disclosure. The example process may be performed by one or more processors 104 of FIG. 2 via the warping engine 146. For example, one or more blocks may be performed by the DPU 144 via warping engine 146.

As shown in FIG. 3, the example process may begin with the processor 104 receiving input image frames of a FOV (or of an overlapping FOV) in different image resolutions (block 302). For example, as shown in FIG. 3, the multiple image frames may include or may be based on an image of a scene produced in a relatively high image resolution (e.g., input image frame 315A), another image of the scene produced in a relatively moderate image resolution (e.g., input image frame 315B) and another image of the scene produced in a relatively low image resolution (e.g., input image frame 315C).

The processor 104 may further receive a regions map (block 304). The regions map may indicate, for an FOV shared by image frames having different image resolutions, various regions of the FOV. These regions of the regions map may be associated with or otherwise assigned to different image resolutions and/or to the input image frames respectively associated with the different image resolutions. FIG. 3 further provides a non-limiting example schematic for the regions map 232 received in block 304. As an example (e.g., as shown in FIG. 3), a regions map 232 may indicate a region of interest 305A and assign an input image frame having a high image resolution, and may further indicate a region of lesser importance 305B and assign another input image frame having a low image resolution to said region of lesser importance. In some embodiments, the regions map 232 may also indicate a region to be deemed as invalid (e.g., of least importance) and may not be assigned to any input image frame. In some embodiments, the regions map 304 may be generated by the ISP 112 or the camera 103 based on sensors (e.g., eye tracking sensor 140A) tracking the fovea of the eye of the user to determine regions of interest within an FOV of an image sensor. Also or alternatively, the regions map 304 may be generated based on object or facial recognition systems (e.g., facial recognition sensor 140B).

At block 306, the processor 104 (e.g., via warping engine 146) may determine a set of coordinates for an output image frame (e.g., as shown by the set of coordinates 307). In some embodiments, the set of coordinates may be scaled, shaped, warped, or otherwise based on parameters of the display device (e.g., display 114). At block 308, the processor may inverse transform the set of coordinates to a virtual domain, thereby resulting in a virtual set of coordinates for the input image frame. The inverse transformation of the set of coordinates to a virtual domain may allow for the processor 104 (e.g., the warping engine 146) to be agnostic to image resolutions of the input image frames in the furtherance of subsequent blocks of the example process. In some embodiments, one or more subsequent steps of the example process may be performed for each coordinate (e.g., virtual coordinate) of the set of coordinates 307 on a coordinate by coordinate basis. For example, steps for each coordinate may be performed in a roster order and/or may be performed in an order based on the capture of input image frames.

Thus, at block 310, the processor 104 (e.g., via warping engine 146) may scale a coordinate (of the set of coordinates) to the regions map size. The regions map 232 may be set to a low image resolution in order to conserve processing bandwidth, as the goal of the regions map 232 is as a tool to determine the input image frame. For example, the warping engine 146 may reduce or otherwise scale the size of the virtual coordinate to be mapped to a corresponding location in the regions map. The processor may then determine the region of the regions map in which the corresponding location for the coordinate is in. For example, the processor may determine that the coordinate falls under the region of interest 305A, a second region 305B, or the like.

At block 312, the processor 104 (e.g., via warping engine 146) may identify an input image frame having the image resolution associated with the coordinate using the regions map. As previously discussed, the regions map 238 may indicate which input image frames are relevant for each region, or the image resolution relevant for each region. For example, the regions map may indicate that a high image resolution or input image frame 315A (having the high image resolution) is relevant for (and therefore associated with) region 305A, while a moderate image resolution or input image frame 315B (having the moderate image resolution) is relevant for region 305B. If the location in the regions map corresponding to the coordinate falls within region 305B, the processor may identify input image frame 315B as having the image resolution associated with the coordinate.

In some embodiments, the association of input image frames or image resolutions to the regions may be done by way of image frame IDs associated with the regions (e.g., as metadata). The processor 104 (e.g., via warping engine 146) may use an image frame ID to access, and/or retrieve pixels from, the stored input image frame identified by the image frame ID, as described in subsequent steps.

For example, at block 314, the processor 104 (e.g., via warping engine 146) may scale the coordinate (e.g., the virtual coordinate) to the size of the identified input image frame. For example, in order to map the coordinate to a corresponding location in the identified input image frame, the size of the coordinate may be rendered to be proportionate to a corresponding location in the identified input image frame. In some embodiments, the processor may determine the size of the input image frame via their respective image frame ID. The input image frames may be stored in a system cache and/or memory 106.

At block 316, the processor 104 (e.g., via warping engine 146) may fetch one or more input pixels from a location in the identified input image frame corresponding to the coordinate. For example, as shown in FIG. 3, if the processor identified input image frame 315B as being relevant for a region 305B of the regions map in which the coordinate would be located, the processor may fetch the input pixels from the location for use in determining and/or generating the image data for the coordinate in the output image frame. In some embodiments, the fetching may be performed by the processor retrieving the pixels from a system cache and/or memory 106 via the image frame ID. In some embodiments, the fetched input pixel from the identified input image frame may be used to generate image data for the output image frame in an area spanning the coordinate.

At block 318, the processor (e.g., via warping engine 146) may warp and/or interpolate the fetched input pixels based on the set of coordinates for the output image frame (block 318). For example, it is contemplated that, based on parameters of a display device, the output image frame may not necessarily share the size, shape, morphology, and/or other distortions of an input image frame. A warp transformation may be performed on each of or one or more of the fetched pixels to align or align towards the size, shape, morphology, and/or other distortions of the output image frame. Furthermore, the processor may interpolate the pixels, as it is contemplated that pixels, locations, and/or samples of the input image frame may not necessarily align with the coordinates or samples of the output image frame. For example, a transformed coordinate of an output pixel may fall in-between sample coordinates of the input image frame. In some embodiments, the warping engine may also fetch pixels surrounding the location in the input image frame associated with the coordinate (e.g., for use in cubic or bilinear interpolation).

As previously discussed, one or more blocks of example process 300 may be performed on a coordinate by coordinate basis (e.g., on a raster scan order). Thus, blocks 310 through 318 may be repeated for each coordinate accordingly.

In some embodiments, the processor 104 (e.g., via warping engine 146) may additionally blend pixels corresponding to locations that are in areas transitioning between regions. For example, a transition area may include areas spanning a border between a region of interest associated with a high image resolution and another region associated with a low image resolution. The processor may cause the image resolution of the transition area to be between the high image resolution and the low image resolution.

At block 320, the processor 104 (e.g., via warping engine 146) may output the output image frame. For example, the processor may cause display of the output image frame via display device 114. For an image data stream or video, multiple output image frames may be displayed sequentially, based on completion of the aforementioned steps for a sequence of sets of multiple input image frames having an overlapping FOV and having different image resolutions.

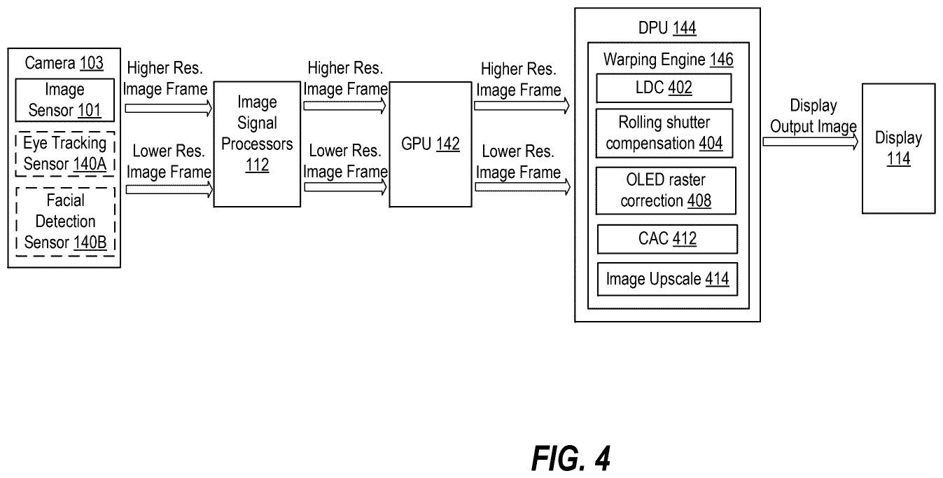

FIG. 4 is a block diagram showing an example data flow path across components used for multi-resolution foveated rendering of image data, according to non-limiting embodiments of the present disclosure. As shown in FIG. 4, the components may include the camera 103, the image signal processor 112, the GPU 142, the DPU 144, and the display 114.

The camera 103 may capture image data of a FOV and generate at least two image frames having two image resolutions. The higher resolution image frame may represent an image frame having a relative image resolution for a region of interest in the FOV. The region of interest may align with where a fovea of the user is gazing at, and this gaze may be detected and/or tracked via the eye tracking sensor 140A. In some embodiments, such region of interest may be static. In some embodiments the region of interest may dynamically change based on the movement of the fovea as tracked via the eye tracking sensor 140A (such region of interest may be referred to herein as an “adaptive fovea region”).

The image signal processors 112 may receive the at least two image frames having the different image resolutions and the overlapping FOV. The input signal processors 112 may perform minor adjustments to the input image frames and/or the camera for further processing at the later stage in the image delivery pipeline, such as autofocus operations (e.g., via AF 133) and auto exposure operations (e.g., via AEC 134). The input signal processors 112 may further include an image front end engine (IFE) 135 configured to receive, determine, or generate a regions map indicating regions of the FOV and image resolutions and/or input image frames assigned to those regions. Although the input image frames are shown in FIG. 4 as being generated by the camera 103, it is contemplated that in some embodiments, the input image frames may be generated by the image signal processors 112 (e.g., by the IFE 135) based on image data captured by the camera 103.

Furthermore, the at least two input image frames may be transmitted to and may be received by a GPU 142. Conventionally, the ISP 112 and/or the GPU 142 would have performed various image processing operations, such as but not limited to lens distortion correction 402, rolling shutter compensation 404, time warp 406, OLED raster correction 408, anamorphic compression, and chromatic aberration correction 412. After these aforementioned image processing operations, the ISP 112 and/or the GPU 142 may generate an output image frame to be transmitted downstream in the image delivery pipeline (e.g., to the DPU 144) for anamorphic decompression and display.

However, as shown in FIG. 4, various embodiments alleviate the processing burden faced by the ISP 112 and/or the GPU 142 by having a warping engine 146 of the DPU 144 perform one or more of the aforementioned operations. For example, as shown in FIG. 4, the warping engine 146 may be configured to perform lens distortion correction (LDC) 402, rolling shutter compensation 404, OLED raster correction 408, chromatic aberration correction 412, and image upscaling 414, in addition to processes for determining output image frame based on the at least two input image frames of different multiple resolutions and the regions map, as described herein.

Furthermore, the use of the warping engine 146 at the DPU 144 to compose the output image frame based on the at least two input image frames of different image resolutions and the regions map may obfuscate the need to perform many of the aforementioned operations. For example, the warping engine 146 need not perform a time warp operation anymore as the warping engine 146 can render the output image frame more efficiently (e.g., as fast as needed) when compared to the ISP 112 and/or the GPU 142. For example, while a GPU's ability to perform the aforementioned image processing operations may be limited by the number of frames per second that the GPU 142 is configured to handle, the DPU 144 comprising the warping engine 146 can process image frames at the same or substantially the same rate as the display 114. In addition, the use of the warping engine 146 to compose the output image frame from the input image frames may obfuscate the need to perform an anamorphic compression and then a subsequent anamorphic decompression because the DPU 144 need not be restricted by the efficiency of the GPU 142.

After the warping engine 146 warps and interpolates pixels from the at least two input image frames based on the regions map and performs the aforementioned corrections, the output image frame may be displayed on display 114.

FIG. 5 shows a flow chart of an example method 500 for processing image data to perform multi-resolution region-based rendering of image data according to some embodiments of the disclosure. The example method 500 of FIG. 5 optimizes image resolution for regions of interest while minimizing image resolution in regions of lesser interest using a warping engine that reduces or avoids redundant processing, resulting in conservation of processing bandwidth and resources, reduced power consumption, and decreased latency. Each of the operations described with reference to FIG. 5 may be performed by one or a combination of a processor 104 (e.g., the DPU 144, the warping engine 146), the GPU 142, and/or the ISP 112.

At block 502, image data is received, that includes one or more input image frames. In some embodiments, the input image frames may have different image resolutions and may have an overlapping FOV. However, in some embodiments, the input image frames may not necessarily be of different image resolutions. For example, in such embodiments, each input image frame may be a portion of a larger image to be combined (e.g., two wide angle images of a 360 camera to be combined into a single image).

In some embodiments, the DPU 144 may receive the image data from a bus coupled to one or more of the GPU 142 or the ISP 112. Also or alternatively, the image data may be received, for example, from a bus coupled to the first camera 103 or from an analog front end (AFE) coupled to the first camera 103. The image data may alternatively be received from a wireless camera, in which the image data is received through one or more of the WAN adaptor 152, the LAN adaptor 153, and/or the PAN adaptor 154. The image data may alternatively be received from a memory location or a network storage location, such as when the image data was previously captured and is now retrieved from memory 106 and/or a remote location through one or more of the WAN adaptor 152, the LAN adaptor 153, and/or the PAN adaptor 154. In some embodiments, the capture of image data may be initiated by a camera application executing on the processor 104, which causes camera control 210 to activate capture of image data by the first camera 103. The image data retrieved at block 502 may be then processed by a processor 104 (e.g., DPU 144, warping engine 146) or other means for processing image data according to the operations described in one or more of the following blocks.

In some embodiments, the one or more image frames may include multiple image frames. The multiple image frames may include, for example, a first image frame having a first image resolution and a second image frame having a second image resolution of the same or overlapping FOV. In some embodiments, the image frames having the different image resolutions may be generated by the ISP 112. In another embodiment, the multiple image frames may be generated by the camera 103.

At block 504, a regions map is received (e.g., by the DPU 144). The regions map may indicate one or more regions of the received image data (e.g., an overlapping FOV shared by the received image data). In some embodiments, the regions map may associate each region with an image parameter (e.g., one of one or more image parameters). For example, in some embodiments, each region may be associated with a different image parameter (e.g., different image resolution, size, portion, image source, etc.). Also or alternatively, the regions map may associate each region with a respective input image frame having a respective image parameter. For example, a region that is of more significance (e.g., a region of interest, a fovea region, a face, etc.) may be assigned a higher image resolution than the image resolution assigned to other regions, or may be assigned an input image frame having a higher image resolution than other input image frames assigned to other regions. Conversely, a region that is of less significance (e.g., a region surrounding a region of interest, a region surrounding a fovea region, a region surrounding a face, etc.) may be assigned a lower image resolution or an input image frame having a lower image resolution. In some embodiments, the regions map may mark or indicate a region as invalid. In some aspects, image processing may be avoided or significantly curtailed for invalid regions of the received image data.

In some embodiments, the regions map may be based on the detection of the fovea of a user and the region of an overlapping FOV of the received image data to which the fovea is gazing at. In some aspects, the regions map may be a dynamic regions map, for which regions may change based on the movement of the fovea. In such aspects, the regions map may be based on tracking a movement of the fovea or the gaze of the fovea towards the FOV. The detection and/or tracking of the fovea may be done via an eye tracking system, such as via eye tracking sensor 140A.

In some embodiments, the regions map may be based on a feature of interest (e.g., a face, an object) that detected or tracked via object recognition. For example, for applications involving the recognition of faces (e.g., automotive systems, security systems), a region of interest in the overlapping FOV may be determined via a facial recognition sensor 140B. The regions map may be generated based on the detected region of interest.

In some embodiments, the regions map may further include areas of the received image data outside of the one or more regions. In some aspects, such areas may be referred to and/or determined as invalid regions/

At block 506, each coordinate of at least a subset of coordinates for an output image frame may be assigned to a region of the regions map. The subset of coordinates may be a portion or an entirety of a set of coordinates of the output image frame (e.g., to be determined or generated). In some embodiments, the subset of coordinates and/or the set of coordinates may define a raster ordered coordinates of the output pixels. As will be discussed herein, input pixels may be warped (e.g., via inverse transform) according to a morphology (e.g., a size, a shape, a tilt, a rotation, a dimension, or other warping property) to achieve the output image frame (e.g., for each of or one or more of the set of coordinates). In some embodiments, block 506 may be performed by the DPU 144 (e.g., via the warping engine 146) determining a set of coordinates for the output image frame. In some embodiments, the set of coordinates may be based on the parameters (e.g., dimensions, distortions, shape, etc.) of the display device 114 configured to display output image data. In some embodiments, assigning each coordinate may further determining, via an inverse transformation of the set of coordinates, a virtual set of coordinates that is scaled to the regions map. For example, the regions map may be set to a lower size and/or resolution (e.g., to preserve processing resources). The processor (e.g., DPU 144, via the warping engine 146) may then determine the region of the regions map in which the corresponding virtual coordinate would be located in. For example, the processor may determine that the coordinate falls under a first region of the regions map assigned to a first input image frame having a first (e.g., higher) image resolution. Conversely, the processor may determine that the coordinate falls under a second region of the regions map assigned to a second input image frame having a second (e.g., lower) image resolution.

At block 508, for each coordinate of the subset of coordinates for the output image frame, the processor may determine input pixels from a corresponding location in one of the input image frames having an image parameter associated with a region assigned to the coordinate. For example, for each coordinate of the subset of coordinates, one or more input pixels may be fetched from a corresponding location in an input image frame having the image resolution associated with the respective region assigned to the coordinate. Thus, block 508 may result in a set of fetched input pixels for the set of coordinates for the output image frame. Also or alternatively, one or more of blocks 506 through 510 may be performed for each coordinate on a coordinate by coordinate basis (e.g., in a raster scan order), and therefore may result in a set of fetched input pixels for the set of coordinates for the output image frame. For example if the processor (e.g., the DPU 144, via the warping engine 146) assigned the coordinate to a first region of the regions map that is assigned to a first input image frame, the processor may fetch one or more input pixels from a corresponding location in the first input image frame for use in determining and/or generating the image data for the coordinate in the output image frame. In some embodiments, fetching the one or more input pixels from the corresponding location in the input image frame may include scaling the coordinate based on the identified input image frame to determine the corresponding location for the coordinate within the input image frame. In some embodiments, the fetching may be performed by the processor retrieving the pixels from a system cache and/or memory 106 via an image frame ID. For example, each region of the regions map may be assigned to an input image frame via their respective image frame ID (e.g., stored as metadata in the regions map).

In some embodiments, for coordinates of the output image frame that are outside of the subset of coordinates and/or which are assigned to invalid regions in the region map, input pixels from corresponding locations in the input image frames may not be fetched. This may improve image processing efficiency and resource efficiency, for example, by avoiding the processing of input pixels in less important or otherwise invalid regions.

At block 510, the output image frame may be determined by warping the set of fetched input pixels to align towards one or more of the set of coordinates (e.g., raster scan ordered coordinates) of the output image frame. For example, each of the one or more pixels from a location corresponding to the coordinate may be warped in size, shape, and/or other morphology to align towards (e.g., adopt or satisfy within a tolerance level of an alignment or matching threshold for) the size, shape, and/or other morphology of the coordinate for the output image frame. Furthermore, the processor may interpolate the pixels, as it is contemplated that pixels, locations, and/or samples of the input image frame may not necessarily align with the coordinates of the output image frame. For example, a pixel of an input image frame may be between coordinates of the output image frame, or a coordinate for the output image frame may be a portion of a pixel in the input image frame. The warping may partition pixels accordingly. In some embodiments, the warping engine may also fetch pixels surrounding the location in the input image frame associated with the coordinate (e.g., for use in cubic or bilinear interpolation). In some embodiments, the warping may include blending at least one fetched input pixel from the first input image frame with at least one fetched input pixel from the second input image frame.

In some embodiments, determining the output image frame may further include performing (e.g., by the warping engine 146 of the DPU 144) one or more of: a lens distortion correction for the output image frame (e.g., using the set of fetched input pixels and/or a set of output image pixels); a rolling shutter correction for the output image frame (e.g., using the set of fetched input pixels and/or a set of output image pixels); a display raster correction for the output image frame (e.g., using a set of output pixels); a time warp transformation for the output image frame (e.g., using the set of fetched input pixels and/or a set of output image pixels); or a chromatic aberration correction for the output image frame (e.g., using the set of fetched input pixels and/or a set of output pixels).

In some embodiments, the received image data may not necessarily have an overlapping FOV. For example, the input image frames may correspond to a top half and a bottom half of a combined FOV formed by combining the input image frames. In such embodiments, each of the input image frames may correspond to regions representing the top half and the bottom half of the region map and may each be associated with a different image parameter. Each coordinate of a set of coordinates for an output image frame may be assigned to one of the top half or the bottom half region. For each coordinate, input pixels from a corresponding location in an input image frame having the image parameter associated with the respective region assigned to the coordinate can be fetched, thereby resulting in a set of fetched input pixels. The output image frame (comprising a full image of the top and bottom half) may be determined by warping the set of fetched input pixels to align towards the set of coordinates for the output image frame.

In one or more aspects, techniques for supporting image processing may include additional aspects, such as any single aspect or any combination of aspects described below or in connection with one or more other processes or devices described elsewhere herein. In a first aspect, supporting image processing may include an apparatus including: a memory storing processor-readable code; and at least one processor coupled to the memory. The at least one processor is configured to: receive image data including one or more image frames; receive a regions map indicating one or more regions in the received image data, wherein the regions map associates each region with one of one or more image parameters; assign, based on the regions map, each coordinate of a subset of coordinates for an output image frame to one of the one or more regions; determine, for each coordinate of the subset of coordinates for the output image frame, one or more input pixels from a corresponding location in one of the one or more image frames having an image parameter associated with a region assigned to the coordinate; and determine the output image frame by warping the one or more input pixels to align towards the subset of coordinates for the output image frame.

Additionally, the apparatus may perform or operate according to one or more aspects as described below. In some implementations, the apparatus includes an image capture device, such as a smart phone. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein.

In a second aspect, in combination with the first aspect, the at least one processor is configured to determine the output image frame by warping the set of one or more input pixels by: interpolating the warped set of one or more input pixels.

In a third aspect, in combination with one or more of the first aspect or the second aspect, the at least one processor is configured to assign each coordinate of the subset of coordinates by: determining a set of coordinates for the output image frame, wherein the set of coordinates includes the subset of coordinates; and determining, via an inverse transformation of the set of coordinates, a virtual set of coordinates that is scaled to the regions map.

In a fourth aspect, in combination with one or more of the first aspect through the third aspect, the at least one processor is configured to determine the output image frame by warping the one or more input pixels by performing one or more of: a lens distortion correction on the one or more input pixels; a rolling shutter correction on the one or more input pixels; a display raster correction on the one or more input pixels; a time warp transformation on the one or more input pixels; or a chromatic aberration correction on the one or more input pixels.

In a fifth aspect, in combination with one or more of the first aspect through the fourth aspect, the one or more image parameters includes at least two different image resolutions, wherein the one or more image frames includes at least a first input image frame having a first image resolution and a second input image frame having a second image resolution, wherein the one or more regions includes at least a first region associated with the first image resolution and a second region associated with the second image resolution, wherein the at least one processor is configured to determine the output image frame by warping the one or more input pixels by: blending at least one of the one or more input pixels from the first input image frame with at least one of the one or more input pixels from the second input image frame.

In a sixth aspect, in combination with one or more of the first aspect through the fifth aspect, the one or more image parameters includes at least two different image resolutions, wherein the one or more regions includes a region of interest, wherein image data associated with the region of interest is of a higher resolution than other image data.

In a seventh aspect, in combination with one or more of the first aspect through the sixth aspect, the at least one processor is further configured to: determine, via an eye tracking sensor, the region of interest in an overlapping field of view (FOV) shared by the one or more input image frames; and generate the regions map based on the region of interest.

In an eighth aspect, a method is disclosed for multi-resolution region-based rendering of image data. The method includes: receiving, by a processor, image data including one or more input image frames; receiving, by the processor, a regions map indicating one or more regions in the received image data, wherein the regions map associates each region with one of one or more image parameters; assigning, by the processor and based on the regions map, each coordinate of a subset of coordinates for an output image frame to one of the one or more regions; determining, by the processor, for each coordinate of the subset of coordinates for the output image frame, one or more input pixels from a corresponding location in one of the one or more input image frames having an image parameter associated with a region assigned to the coordinate; and determining, by the processor, the output image frame by warping the one or more input pixels to align towards the subset of coordinates for the output image frame.

In a ninth aspect, in combination with the eighth aspect, determining the output image frame by warping the set of one or more input pixels includes: interpolating, by the processor, the one or more input pixels.

In a tenth aspect, in combination with one or more of the eighth aspect through the ninth aspect, assigning each coordinate of the subset of coordinates for the output image frame includes: determining a set of coordinates for the output image frame, wherein the set of coordinates includes the subset of coordinates; and determining, via an inverse transformation of the set of coordinates, a virtual set of coordinates that is scaled to the regions map.

In an eleventh aspect, in combination with one or more of the eighth aspect through the tenth aspect, determining the output image frame by warping the one or more input pixels includes performing one or more of: a lens distortion correction on the one or more input pixels; a rolling shutter correction on the one or more input pixels; a display raster correction on the one or more input pixels; a time warp transformation on the one or more input pixels; or a chromatic aberration correction on the one or more input pixels.

In a twelfth aspect, in combination with one or more of the eighth aspect through the eleventh aspect, the one or more image parameters includes at least two different image resolutions, wherein the one or more input image frames includes at least a first input image frame having a first image resolution and a second input image frame having a second image resolution, wherein the one or more regions includes at least a first region associated with the first image resolution and a second region associated with the second image resolution, wherein determining the output image frame by warping the one or more input pixels includes: blending, by the processor, at least one of the one or more input pixels from the first input image frame with at least one of the one or more input pixel from the second input image frame.

In a thirteenth aspect, in combination with one or more of the eighth aspect through the twelfth aspect, the one or more image parameters includes at least two different image resolutions, wherein the one or more regions include a region of interest, wherein the image resolution associated with the region of interest is of a higher image resolution of the two different image resolutions.

In a fourteenth aspect, in combination with one or more of the eighth aspect through the thirteenth aspect, the method further includes: determining, via an eye tracking sensor, the region of interest in an overlapping field of view (FOV) shared by the one or more input image frames; and generating, by the processor, the regions map based on the region of interest.

In a fifteenth aspect, an image capture device is disclosed for multi-resolution region-based rendering of image data. The image capture device includes: an image sensor configured to generate image data including at least two input image frames; a memory storing processor-readable code; and at least one processor coupled to the memory and to the image sensor. The at least one processor is configured to: receive the image data including the at least two input image frames; receive a regions map indicating at least two regions in the received image data, wherein the regions map associates each region with one of at least two different image parameters; determine, based on the received image data, a set of coordinates for an output image frame; assign, based on the regions map, each coordinate of a set of coordinates for an output image frame to one of the at least two regions, wherein the set of coordinates define a morphology for the output image frame; determine, for each coordinate for the output image frame, one or more input pixels from a corresponding location in one of the at least two input image frames having an image parameter associated with a region assigned to the coordinate; and determine the output image frame by warping the one or more input pixels to align towards the morphology defined by set of coordinates for the output image frame and interpolating the one or more input pixels after warping the one or more input pixels.

In a sixteenth aspect, in combination with the fifteenth aspect, the at least one processor is configured to determine the output image frame by warping the one or more input pixels by performing one or more of: a lens distortion correction for the output image frame; a rolling shutter correction for the output image frame; a display raster correction for the output image frame; a time warp transformation for the output image frame; or a chromatic aberration correction for the output image frame.

In a seventeenth aspect, in combination with one or more of the first aspect through the sixteenth aspect, the at least two different image parameters includes at least two different image resolutions, wherein the at least two input image frames includes at least a first input image frame having a first image resolution and a second input image frame having a second image resolution, wherein the at least two regions includes at least a first region associated with the first image resolution and a second region associated with the second image resolution, wherein the at least one processor is configured to determine the output image frame by: blending at least one fetched input pixel from the first input image frame with at least one of the one or more input pixels from the second input image frame.

In an eighteenth aspect, in combination with one or more of the first aspect through the seventeenth aspect, the at least two different image parameters includes at least two different image resolutions, wherein the at least two regions include a region of interest, wherein the image resolution associated with the region of interest is of a higher image resolution of the two different image resolutions.

In a nineteenth aspect, in combination with one or more of the first aspect through the eighteenth aspect, the image capture device further includes: an eye tracking sensor. The at least one processor is further configured to: determine, via the eye tracking sensor, the region of interest in the FOV; and generate the regions map based on the region of interest.

In a twentieth aspect, in combination with one or more of the first aspect through the nineteenth aspect, the image capture device further includes a facial recognition sensor. The at least one processor is further configured to: determine, via the facial recognition sensor, a region of interest in the FOV; and generate the regions map based on the region of interest.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art will understand that one or more blocks (or operations) described with reference to FIGS. 3 and 5 may be combined with one or more blocks (or operations) described with reference to another of the figures. For example, one or more blocks (or operations) of FIG. 3 may be combined with one or more blocks (or operations) of FIGS. 1-2. As another example, one or more blocks associated with FIG. 5 may be combined with one or more blocks (or operations) associated with FIGS. 1-2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
receiving, by a processor, image data comprising one or more input image frames;
receiving, by the processor, a regions map indicating one or more regions in the image data, wherein the regions map associates each region with one of one or more image parameters;
assigning, by the processor and based on the regions map, each coordinate of a subset of coordinates for an output image frame to one of the one or more regions;
determining, by the processor, for each coordinate of the subset of coordinates for the output image frame, one or more input pixels from a corresponding location in one of the one or more input image frames having an image parameter associated with a region assigned to the coordinate; and
determining, by the processor, the output image frame by warping the one or more input pixels to align towards the subset of coordinates for the output image frame.

2. The method of claim 1, wherein determining the output image frame by
warping the one or more input pixels comprises:
interpolating, by the processor, the one or more input pixels.

3. The method of claim 1, wherein assigning each coordinate of the subset of
coordinates for the output image frame comprises:
determining a set of coordinates for the output image frame, wherein the set of coordinates includes the subset of coordinates; and
determining, via an inverse transformation of the set of coordinates, a virtual set of coordinates that is scaled to the regions map.

4. The method of claim 1, wherein determining the output image frame comprises
performing one or more of:
a lens distortion correction on the one or more input pixels;
a rolling shutter correction on the one or more input pixels;
a display raster correction on the one or more input pixels;
a time warp transformation on the one or more input pixels; or
a chromatic aberration correction on the one or more input pixels.

5. The method of claim 1, wherein the one or more image parameters comprises at least two different image resolutions, wherein the one or more input image frames comprises at least a first input image frame having a first image resolution and a second input image frame having a second image resolution, wherein the one or more regions comprises at least a first region associated with the first image resolution and a second region associated with the second image resolution, wherein determining the output image frame by warping the one or more input pixels comprises:
blending, by the processor, at least one of the one or more input pixels from the first input image frame with at least one of the one or more input pixel from the second input image frame.

6. The method of claim 1, wherein the one or more image parameters comprises at least two different image resolutions, wherein the one or more regions include a region of interest, wherein the image resolution associated with the region of interest is of a higher image resolution of the two different image resolutions.

7. The method of claim 6, further comprising:
determining, via an eye tracking sensor, the region of interest in an overlapping field of view (FOV) shared by the one or more input image frames; and
generating, by the processor, the regions map based on the region of interest.

8. An apparatus, comprising:
a memory storing processor-readable code; and
at least one processor coupled to the memory, the at least one processor being configured to:
receive image data comprising one or more input image frames;
receive a regions map indicating one or more regions in the image data, wherein the regions map associates each region with one of one or more image parameters;
assign, based on the regions map, each coordinate of a subset of coordinates for an output image frame to one of the one or more regions;
determine, for each coordinate of the subset of coordinates for the output image frame, one or more input pixels from a corresponding location in one of the one or more input image frames having an image parameter associated with a region assigned to the coordinate; and
determine the output image frame by warping the one or more input pixels to align towards the subset of coordinates for the output image frame.

9. The apparatus of claim 8, wherein the at least one processor is configured to
determine the output image frame by warping the one or more input pixels by:
interpolating the one or more input pixels.

10. The apparatus of claim 8, wherein the at least one processor is configured to
assign each coordinate by:
determining, a set of coordinates for the output image frame, wherein the set of coordinates includes the subset of coordinates; and
determining, via an inverse transformation of the set of coordinates, a virtual set of coordinates that is scaled to the regions map.

11. The apparatus of claim 8, wherein the at least one processor is further
configured to determine the output image frame by performing one or more of:
a lens distortion correction on the one or more input pixels;
a rolling shutter correction on the one or more input pixels;
a display raster correction on the one or more input pixels;
a time warp transformation on the one or more input pixels; or
a chromatic aberration correction on the one or more input pixels.

12. The apparatus of claim 8, wherein the one or more image parameters comprises at least two different image resolutions, wherein the one or more input image frames comprises at least a first input image frame having a first image resolution and a second input image frame having a second image resolution, wherein the one or more regions comprises at least a first region associated with the first image resolution and a second region associated with the second image resolution, wherein the at least one processor is configured to determine the output image frame by warping the one or more input pixels by:
blending at least one of the one or more input pixels from the first input image frame with at least one of the one or more input pixels from the second input image frame.

13. The apparatus of claim 8, wherein the one or more image parameters comprises at least two different image resolutions, wherein the one or more regions includes a region of interest, wherein image data associated with the region of interest is of a higher resolution than other image data.

14. The apparatus of claim 13, wherein the at least one processor is further configured to:
determine, via an eye tracking sensor, the region of interest in an overlapping field of view (FOV) shared by the one or more input image frames; and
generate the regions map based on the region of interest.

15. An image capture device, comprising:
an image sensor configured to generate image data comprising at least two input image frames;
a memory storing processor-readable code; and
at least one processor coupled to the memory and to the image sensor, the at least one processor configured to:
receive the image data comprising the at least two input image frames;
receive a regions map indicating at least two regions in the image data, wherein the regions map associates each region with one of at least two different image parameters;
determine, based on the image data, a set of coordinates for an output image frame;
assign, based on the regions map, each coordinate of a set of coordinates for an output image frame to one of the at least two regions;
determine, for each coordinate for the output image frame, one or more input pixels from a corresponding location in one of the at least two input image frames having an image parameter associated with a region assigned to the coordinate; and
determine the output image frame by warping the one or more input pixels to align towards the set of coordinates for the output image frame and interpolating the one or more input pixels after warping the one or more input pixels.

16. The image capture device of claim 15, wherein the at least one processor is
configured to determine the output image frame by performing one or more of:
a lens distortion correction on the one or more input pixels;
a rolling shutter correction on the one or more input pixels;
a display raster correction on the one or more input pixels;
a time warp transformation on the one or more input pixels; or
a chromatic aberration correction on the one or more input pixels.

17. The image capture device of claim 15, wherein the at least two different image parameters comprises at least two different image resolutions, wherein the at least two input image frames comprises at least a first input image frame having a first image resolution and a second input image frame having a second image resolution, wherein the at least two regions comprises at least a first region associated with the first image resolution and a second region associated with the second image resolution, wherein the at least one processor is configured to determine the output image frame by:
blending at least one fetched input pixel from the first input image frame with at least one of the one or more input pixels from the second input image frame.

18. The image capture device of claim 15, wherein the at least two different image parameters comprises at least two different image resolutions, wherein the at least two regions include a region of interest, wherein the image resolution associated with the region of interest is of a higher image resolution of the two different image resolutions.

19. The image capture device of claim 18, further comprising an eye tracking sensor, wherein the at least one processor is further configured to:
determine, via the eye tracking sensor, a region of interest; and
generate the regions map based on the region of interest.

20. The image capture device of claim 18, further comprising a facial recognition sensor, wherein the at least one processor is further configured to:
determine, via the facial recognition sensor, a region of interest; and
generate the regions map based on the region of interest.
